(19) United States
(12) Patent Application Publication
(10) Pub. No.: US 2002/0091534 A1
(43) Pub. Date: Jul. 11, 2002

(54) Facility for conducting consumer product research

(76) Inventors: Carol Kohn Berning, Cincinnati, OH (US); Robb Eric Olsen, Cincinnati, OH (US); Thomas Michael McCauley, Lake Villa, IL (US); Paula Joan Asmus, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 09/755,353

(22) Filed: Jan. 5, 2001

(51) Int. Cl. G06F 17/60

(52) U.S. Cl. 705/1

(57) ABSTRACT

A method and facility for conducting consumer product research, including the steps of configuring a mock environment so as to test a product in a desired context, placing at least one consumer within the mock environment for testing the product, and collecting information during testing of the product. The facility further includes an area for remotely controlling the information collecting means, as well as at least one area for directly observing the mock environment. The mock environment typically simulates one or more rooms in a house, but can be configured to simulate other places where consumer activity takes place such as a store. The facility is also able to be configured for the demographics of a particular consumer panel, hosting a specified event, and testing a prototype device.

### FIELD OF THE INVENTION

This invention relates to a facility for conducting consumer product research, and more particularly, to a facility which provides a mock environment to be configured for testing a product in a desired context while collecting information during testing of such product.

### BACKGROUND OF THE INVENTION

It is well known for companies to perform extensive consumer research prior to the introduction of a new product. In this way, the positive and negative aspects of the product are revealed, as well as the individual tastes of consumers, so that product designs may be evaluated and improved. There are several different types of consumer research which are currently performed within the industry, including focus groups, one-on-one in-depth interviews, in-home visits, non-intrusive observation, and storytelling. Quantitative research methods also include product use testing, segmentation research, attitude questionnaires, concept testing, need/gap surveys, and habits and practices surveys. Such research is conducted in a variety of different forms, including printed questionnaires, telephone interviews, in-person interviews, mall intercepts, door to door interviews, the Internet, etc.

As indicated above, testing has oftentimes occurred by placing the product in a number of consumers' homes so that it can be utilized within an environment where it typically will perform its intended function. Moreover, it has been found that in-home testing affords the consumer tester a comfortable environment in which to conduct product use. Unfortunately, however, there are several disadvantages associated with in-home testing. For example, there is little if any control over the environment since the product is being utilized on the consumer's private property. Accordingly, the consumer alone has the responsibility of not only recording her observations and insights during product testing, but also of verifying proper use of the product. In-home testing is also limiting by its nature due to its available infrastructure and inability to reconfigure the environment. It is also inefficient in the collection of information since reliance is placed on the consumer to return her feedback or resources must be delegated to retrieve it.

Conversely, off-site testing is typically conducted in a conference room or other sterile environment. While this permits better collection of information and more control over product use, product testing is generally not performed within the desired context. Even if conditions are simulated for product use, they are not within an realistic environment which engenders comfort on the part of the consumer. This discourages participation and openness, with the amount and substance of feedback provided regarding the product having a corresponding reduction in completeness.

Therefore, there exists a need for a facility which permits product testing to be performed in context and in an environment comfortable to the consumer. It is also desirable that such facility include the infrastructure to enable collection of information, such as consumer feedback, while retaining a measure of control over the environment. In order to allow several products to be tested under a variety of conditions, the facility should further have the ability to be reconfigured to reflect the context desired.

### SUMMARY OF THE INVENTION

In a first embodiment of the present invention, a method of conducting consumer product research is disclosed as including the steps of configuring a mock environment so as to test a product in a desired context, placing at least one consumer within the mock environment for testing the product, and collecting information during testing of the product. The method further may include the step of collecting information upon completion of product testing, such as bringing individual consumers together after product testing to discuss it in a focus group. The method may also include the step of screening a pool of candidates in order to constitute a consumer panel for testing a desired product, where either the consumer panel is configured for a particular mock environment or the mock environment is configured for a particular consumer panel.

In a second embodiment of the present invention, a facility for conducting consumer product research is disclosed as including at least one mock environment configured for testing a product in a desired context and at least one device for collecting information during testing of the product in the mock environment. The facility further includes an area for remotely controlling the information collecting devices, as well as at least one area for directly observing the mock environment. The mock environment typically simulates one or more rooms in a house, but can be configured to simulate other places where consumer activity takes place such as a commercial establishment. The facility is also able to be configured for the demographics of a particular consumer panel, hosting a specified event, and testing a prototype device.

### BRIEF DESCRIPTION OF THE DRAWINGS

While the specification concludes with claims particularly pointing out and distinctly claiming the subject matter that is regarded as the present invention, it is believed that the invention will be better understood from the following description, which is taken in conjunction with the accompanying drawings:

FIG. 1 is a schematic diagram depicting a preferred embodiment of the facility of the present invention; and,

FIG. 2 is a schematic diagram depicting an alternative embodiment of the facility of the present invention.

### DETAILED DESCRIPTION OF THE INVENTION

A preferred embodiment of the present invention involves a facility for conducting consumer product research. In particular, the facility preferably includes at least one mock environment configured for testing a product in a desired context and at least one device for collecting information during testing of the product in the mock environment. It will be understood that several of the terms, as utilized herein, have specialized meanings and therefore are defined so as to reflect a proper understanding.

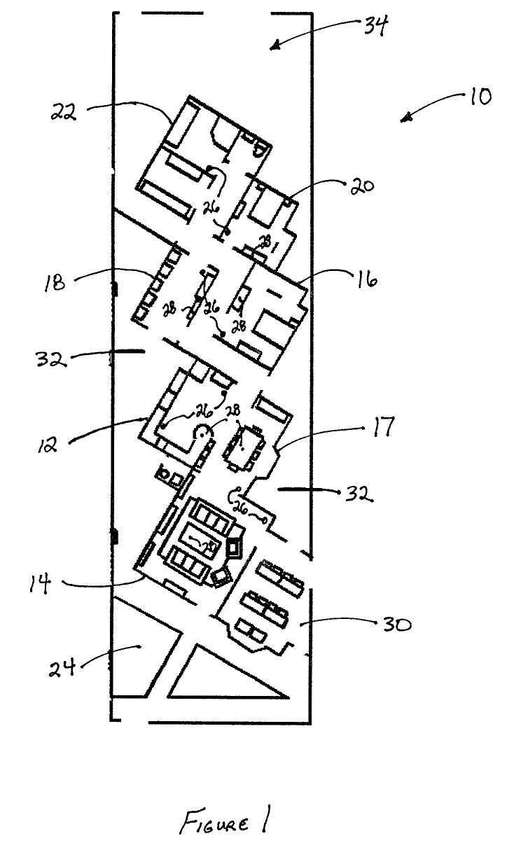

It will be seen from FIG. 1 that facility 10 is configured to simulate various areas in or around a typical house (i.e., kitchen 12, family room 14, nursery 16, dining room 17, laundry room 18, master bedroom 20, master bathroom 22, and front yard/patio 24). Each such area is an example of a “mock environment,” which is defined as an environment which is realistically simulated so as to enable a consumer to interact with a given product in a frame of mind substantially like that in a corresponding real environment. By furnishing each room of facility 10 as it typically would be in a real home, with the normal attendant infrastructure, it is able to be configured so a given product can be tested in a desired context. Facility 10 has the added advantage of being outfitted with the latest technological infrastructure (e.g., broadband, satellite, Internet, cable modem, phone, wireless/wired networking, interactive television, DSL, distributed video network, etc.) so that high tech products may be tested in an efficient manner. It will be appreciated that such high tech infrastructure is not available in the typical home and thus eliminates in-home testing of these type products due to lack of capability.

In order to collect information during testing of the product, facility 10 also includes a variety of recording devices, such as video cameras and microphones 26 and 28, respectively, interspersed throughout. This enables consumer feedback regarding the product to be automatically collected and recorded for analysis (concurrent and later) without imposing such functions upon the consumer testing the product. Such devices may also be utilized for broadcasting the information in real time so that experts can review the information. Accordingly, a control room 30 separate from the mock environment is provided to interface with such devices without interfering with the consumer. Of course, control room 30 will preferably include other equipment as needed. It is also preferred that various observation areas 32 be provided around the mock environment to enable direct viewing of the product testing. Additional areas, such as a staging area 34, may be provided as required in order to orient consumers prior to product testing or otherwise obtain consumer feedback after testing has been completed. Staging area 34 may also be utilized as a docking area where items and infrastructure are received and shipped from facility 10.

It will further be appreciated that the term “consumer” herein is a person or animal which uses, interacts with, and/or purchases a product. Additionally, the term “product” herein not only refers to a physical item, but also to a service or a communication (e.g., a printed advertisement, website, or commercial). The term “information” includes factual and quantitative data acquired from a recording or broadcasting device, where the information involves both consumer feedback and other types objective data pertaining to consumer interaction with the product. By “in context,” it is meant that use, interaction with, and/or purchasing of a product is accomplished within an intended environment and in an intended manner, as facilitated by the configuration of the mock environment. This will involve modifying the mock environment as necessary for a given product, with facility 10 being easily reconfigured to suit such needs. It will also be understood that “testing” of the product may involve its functionality, appearance, instructions for use, results or other aspect thereof.

With regard to the mock environment, it will be appreciated that modifications may also be made thereto for a particular consumer profile, for hosting a specified event, or for testing a prototype device. For example, the mock environment may be furnished in such a way as to make consumers testing a product more comfortable with the surroundings. This may be reflected in the type, cost and arrangement of furnishings, how and in what color the mock environment is decorated, etc. It is also recognized that testing of a particular product may best be accomplished within the context of a specified event (e.g., a girls slumber party, a Super Bowl party, a family dinner) and the flexibility of the mock environment permits it to be configured accordingly.

One of the advantages of facility 10 is the ability to test prototype devices in a manner which allows a consumer to believe she is testing it without her not really having control. Rather than build a costly new feature into a device, such as a household appliance, it may be controlled outside the mock environment (i.e., via control room 30 or within an observation area 32 having a direct connection to such appliance). Control of the appliance may also be within the mock environment by an assistant to the consumer. In this way, prototype devices need not be in an aesthetically pleasing fully functional state prior to testing within a realistic simulated environment.

Another aspect to prototype testing is simulating operation of the product by providing a mock product within the mock environment. A “mock product” is defined herein as a product which appears fully functional, but one or more elements are controlled in some other manner to simulate full or key functionality. This permits the consumer to evaluate the results of such device without the consumer knowing that the product does not function. One example of this is to place a finished product within the appliance from outside the mock environment by a third party without the consumer's knowledge. Thus, consumer research is able to be collected without investing time and cost of building the feature into the appliance.

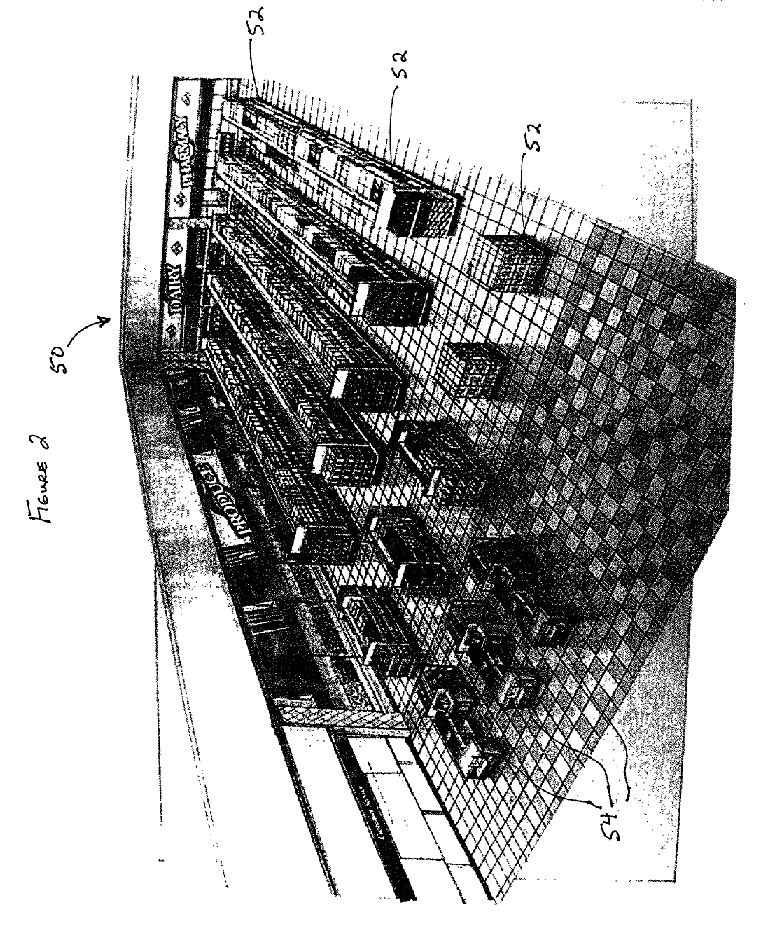

It will also be seen from FIG. 2 that facility 10 may be configured to be a commercial establishment (e.g., a retail store, grocery, pharmacy, farmer's market, mass merchandiser, hair salon, restaurant, kiosk, club, wholesaler, etc.) so as to obtain research related to a consumer's purchasing decisions and habits. Moreover, the consumer may be an employee of such commercial establishment which interacts with such product (e.g., a stock person, cashier, etc.) and testing can be conducted to evaluate how different configurations of the mock environment and/or the product design impact their duties. As seen in the store environment 50 shown, there are a plurality of shelving units 52 arranged in size and configuration to form aisles or rows like that typically confronted by a consumer. In order to further simulate the experience by this mock environment, a number of checkout stations 54 are provided, as is signage and arrangements for various departments (e.g., produce, dairy, pharmacy).

Of course, various devices are provided within store environment 50 to collect information. Besides video and audio devices, however, other devices may be provided to measure certain quantitative data (i.e., sensors within shelving units 52 or on the products themselves to detect when removed). Certainly, research with respect to the positioning of products on a shelving device 52 or within areas of store environment 50 could be readily available in this scenario.

In light of facility 10 and its express purpose of conducting consumer product research, it will be understood that a method of conducting such research arises out of testing products in such mock environment. Accordingly, such method involves the steps of configuring a mock environment so as to test a product in a desired context, placing at least one consumer within the mock environment for testing the product, and collecting information during testing of the product. Preferably, collection of the information is done automatically by devices which do not require assistance or attention from the consumer doing the testing. As stated hereinabove, other approaches may involve some attempt at simulating an environment (although not to the extent of facility 10 as described). Such environments have not combined a realistic mock environment with the equipment and infrastructure of the present invention which permits easy reconfiguration thereof to suit a particular need or context.

Prior to placing a consumer within the mock environment, it is preferred that a screening among a pool of candidates be performed so as to properly match consumers with a particular product, a particular mock environment, a particular context, and/or a particular demographic. In this way, a consumer panel (known as a longitudinal panel) may also be formed which can be utilized to conduct product research several times. This longitudinal panel is valuable in the sense that the consumers thereon become more comfortable within the mock environment and better relate their observations and insights in terms of both quantity and depth. Of course, certain contexts will require that the consumers never to have been within the mock environment or that such consumers can be utilized only a single time.

One approach is to permit individual consumers to test the product within certain areas of the mock environment and then bring them together for a discussion to share their thoughts and observations. This may be done within an area of the mock environment (e.g., in family room 14) or outside of such mock environment (e.g., staging area 34). Also, follow-up research after product testing in the mock environment may be conducted with the consumers via questionnaires, interviews, or the like.

While particular embodiments and/or individual features of the present invention have been illustrated and described, it would be obvious to those skilled in the art that various other changes and modifications can be made without departing from the spirit and scope of the invention. Further, it should be apparent that all combinations of such embodiments and features are possible and can result in preferred executions of the invention.

What is claimed is:

1. A method of conducting consumer product research, comprising the following steps:
(a) configuring a mock environment so as to test a product in a desired context;
(b) placing at least one consumer within said mock environment for testing said product; and
(c) collecting information during testing of said product.

2. The method of claim 1, said mock environment further comprising a plurality of areas within a simulated house.

3. The method of claim 2, wherein at least one consumer is placed within an area conforming to the desired context for testing said product.

4. The method of claim 1, further comprising the step of collecting information upon completion of testing said product.

5. The method of claim 1, further comprising the step of broadcasting said information during testing of said product.

6. The method of claim 1, further comprising the step of analyzing said information.

7. The method of claim 1, wherein said information is feedback from said consumer.

8. The method of claim 1, wherein said information is quantitative data measured from interaction between said consumer and said product.

9. The method of claim 1, further comprising the step of screening a pool of candidates to become a consumer panel for testing a desired product.

10. The method of claim 9, wherein said mock environment is configured to match the demographics of said consumer panel.

11. The method of claim 9, wherein said consumer panel is configured to match said mock environment.

12. The method of claim 1, wherein said mock environment is configured for hosting a desired event during which said product is tested.

13. The method of claim 7, wherein said consumer feedback is recorded audiovisually.

14. The method of claim 1, wherein operation of said product is controlled by a third party.

15. The method of claim 1, wherein operation of said product is simulated in said mock environment through control of a third party.

16. The method of claim 1, wherein said mock environment is a commercial establishment.

17. The method of claim 1, wherein said product is a service.

18. The method of claim 1, wherein said product is a form of communication.

19. The method of claim 7, wherein said consumer panel is utilized to test a plurality of products within said mock environment.

20. A facility for conducting consumer product research, comprising:
(a) at least one mock environment configured for testing a product in a desired context; and
(b) at least one device for collecting information during testing of said product in said mock environment.

21. The facility of claim 20, said mock environment further comprising at least one area in a simulated house.

22. The facility of claim 20, said mock environment further comprising an area in a simulated commercial establishment.

23. The facility of claim 20, further comprising an area separate from said mock environment for remotely controlling said information collecting devices.

24. The facility of claim 20, further comprising an area separate from said mock environment for directly viewing product testing therein.

25. The facility of claim 20, said information collecting devices further collecting information after testing of the product in a separate setting.

26. The facility of claim 20, wherein said mock environment is configured for a particular consumer profile.

27. The facility of claim 20, wherein a particular consumer profile is matched with said mock environment.

28. The facility of claim 20, wherein said mock environment is configured for hosting a specified event.

29. The facility of claim 20, wherein said mock environment is configured for testing a prototype device.

30. The facility of claim 20, wherein said mock environment is constructed with infrastructure that is configurable for testing of a given product.
